(19) United States
(12) Patent Application Publication
(10) Pub. No.: US 2026/0299937 A1
(43) Pub. Date: Oct. 1, 2026

(54) METADATA PLATFORM FOR CONFIGURATION MANAGEMENT OF INTERDEPENDENT SOFTWARE COMPONENTS

(71) Applicant: eBay Inc., San Jose, CA (US)

(72) Inventors: Qi JIANG, Shanghai (CN); Zhengqing QIU, Singapore (SG); Yin WAN, Shanghai (CN); Yan WU, Shanghai (CN)

(21) Appl. No.: 19/095,996

(22) Filed: Mar. 31, 2025

(51) Int. Cl. G06F 8/71

(52) U.S. Cl. CPC G06F 8/71

(57) ABSTRACT

Some aspects relate to technologies for managing interdependent software components in a system. In accordance with some aspects, a knowledge graph for a system is generated using a first language model to extract data from system configuration information. The knowledge graph includes nodes representing the interdependent software components and entities identified from the system configuration information, as well as edges representing relationships among the interdependent software components and the entities. When new system configuration information for a system update is received, generic update metadata for the system is generated using a second language model to process data based on requirements metadata from the new system configuration information and graph data retrieved from the knowledge graph. The generic update metadata is transformed into component-specific metadata for each interdependent software components, and a configuration for each of the interdependent software components is updated using the component-specific metadata.

### BACKGROUND

A system composed of multiple interdependent software components typically functions as an integrated whole where each software component plays a specific role, yet is reliant on the other parts to achieve a common objective. These software components, often developed using various programming languages and technologies, can interact through well-defined interfaces or APIs, allowing them to exchange data and commands seamlessly. This architecture enhances the system's flexibility and scalability, enabling each software component to be updated or replaced independently without disrupting the overall functionality. Such systems are commonly used in complex applications like web services, where different software components handle tasks such as user authentication, data processing, and backend storage, creating a robust and efficient ecosystem.

In recent years, the complexity of dependencies between software components of systems has led to significantly high communication costs for managing updates to the interdependent software components. Coordinating across multiple teams managing different software components requires extensive discussions to ensure all software components are aligned. Amont other things, this leads to delays and inefficiencies in implementing system updates. In addition, agreements and consensus reached during certain projects are often difficult to manage and carry forward, leading to recurring discussions and re-alignments in future initiatives, exacerbating the delays and inefficiencies.

### SUMMARY

Some aspects of the present technology relate to, among other things, a metadata platform for configuration management of interdependent software components. The technology addresses the complexities and inefficiencies associated with managing updates to systems composed of multiple interdependent software components. The present technology introduces a system management platform that generates a knowledge graph from system configuration information, capturing entities, software components, their relationships, and their attributes, including configuration metadata for configurations of the software components. This knowledge graph is used to facilitate intelligent recommendations and dependency analysis for managing software components. When a system update is received, the platform extracts requirements metadata from new system configuration information and queries the knowledge graph to identify impacted components. The platform generates generic update metadata, which is transformed into component-specific metadata to update the configurations of the impacted software components. This approach reduces manual intervention, minimizes errors, and enhances the efficiency of implementing system updates, ensuring consistency and alignment across the entire system.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating an example operation for preparing a knowledge graph for a system in accordance with some implementations of the present disclosure;

FIG. 3 is a block diagram illustrating an example knowledge graph in accordance with some implementations of the present disclosure;

FIG. 4 is a block diagram illustrating an example operation for generating generic update metadata for software components impacted by a system update in accordance with some implementations of the present disclosure;

FIG. 5 is a flow diagram showing an example method for configuration management of interdependent software components in accordance with some implementations of the present disclosure;

FIG. 6 is a flow diagram showing an example method for preparing a knowledge graph for a system to facilitate component management for system updates in accordance with some implementations of the present disclosure;

FIG. 7 is a flow diagram showing an example method for employing a knowledge graph for a system to update configurations of software components based on a system update in accordance with some implementations of the present disclosure; and

FIG. 8 is a block diagram of an exemplary computing environment suitable for use in implementations of the present disclosure.

### DETAILED DESCRIPTION

### Overview

Managing a system requires seamless orchestration across multiple software components. Conventionally, this is a manual process that begins with gathering comprehensive business requirements, policies, and UI content for a system update. An early step involves identifying all the software components that require changes or updates based on these requirements. This identification ensures a clear scope of work and avoids overlooked dependencies.

Once software components impacted by a system update are identified, engineers configure each software component and integrate their specific logic into the overall framework. Along this journey, maintaining data integrity is essential. Continuous validation tests, coupled with robust database management, play a role in ensuring consistency across the interdependent software components.

However, manual processes for configuration, data handling, and code adjustments across various software components in a system introduce inefficiencies. These manual steps often create bottlenecks, increasing the risk of inconsistencies and misalignments, which ultimately slow down the end-to-end delivery of the program.

With the continuous evolution of systems, many software components have transitioned to being configuration-driven. Configuration-driven software components are software modules or units whose behavior and functionality are impacted by external configuration data, rather than being entirely hardcoded directly into the application's code. This allows for flexibility and adaptability by updating configurations without code changes (or only minimal code changes) to the software components. This shift has enabled faster and more efficient development, as configurations allow teams to make adjustments without diving deep into the codebase for every change.

While the shift to configuration-driven development has improved efficiency at the individual component level allowing certain software components to be reconfigured without deep code changes, the approach has conventionally been limited to each software component independently of other software components. In particular, such improvements remain siloed, limited to individual components rather than an end-to-end pipeline. The resulting manual tasks for orchestrating consistent configurations still lead to bottlenecks, rework, and potential misalignments when multiple software components in a system must collectively adapt to a system update.

For instance, at the component level, the launch process for each system update faces delays due to manual tasks performed by engineers. For each individual software component, engineers must gather specific requirements, update configuration files, and manage data entries in databases. Each configuration update requires meticulous validation through tests, ensuring proper alignment with program goals. Additionally, any adjustment to a component's logic demands corresponding code modifications, adding complexity. The reliance on manual intervention in each software component's configuration and logic update introduces potential for errors and inefficiencies, slowing down progress.

Aspects of the technology described herein provide an improved approach to managing updates to interdependent software components of a system that addresses the technical shortcomings of existing approaches. The present technology introduces a system management platform that generates a knowledge graph from system configuration information, capturing entities, software components, and their relationships, and employs the generated knowledge graph to identify software components impacted by a system update and to update the impacted software components.

To generate a knowledge graph for a system, the platform accesses system configuration information, which includes details about the setup and operation of the software components. This information can be parsed into smaller snippets, which are then processed by a language model to extract key entities, software components, their relationships and their attributes, including configuration metadata for the software components. The extracted data is used to prepare a knowledge graph. The knowledge graph is stored in a graph database, with nodes representing the software components and entities with their corresponding attributes, and edges denoting their relationships.

When a system update is required, the platform processes new system configuration information to extract requirements metadata. The requirements metadata is used to query the knowledge graph, retrieving relevant graph data about impacted entities and software components. The retrieved graph data, along with the requirements metadata, are processed by a language model to generate generic update metadata. This generic update metadata identifies impacted software components and entities provides a high-level description of the changes needed for the system update.

The platform then analyzes the generic update metadata to determine the specific configuration changes required for each impacted software component. This involves translating the generic update metadata into component-specific metadata, which details the exact changes needed for each software component. The component-specific metadata is used to update the configurations of the impacted software components, ensuring that the system update is implemented accurately and efficiently.

Aspects of the technology described herein provide a number of improvements over existing techniques for managing updates to systems of interdependent software components. For instance, the technology described herein significantly reduces the complexities and inefficiencies associated with managing updates to systems composed of multiple interdependent software components. By generating a knowledge graph from system configuration information, the technology provides a comprehensive and structured representation of the system, capturing entities, software components, and their relationships. This structured approach enables intelligent recommendations and dependency analysis, ensuring that all impacted components are accurately identified and addressed during system updates. The use of language models to extract requirements metadata and generate generic update metadata further streamlines the update process, minimizing manual intervention and reducing the risk of errors.

Additionally, the technology enhances the efficiency of implementing system updates by transforming generic update metadata into component-specific metadata, which details the exact changes needed for each software component. This precise and automated approach ensures that configurations of the impacted software components are updated accurately and consistently, maintaining alignment across the entire system. The ability to manage updates in this manner not only accelerates the update process but also improves the overall reliability and performance of the system, making it more adaptable to evolving requirements and reducing downtime.

### Example System for Configuration Management of Interdependent Software Components

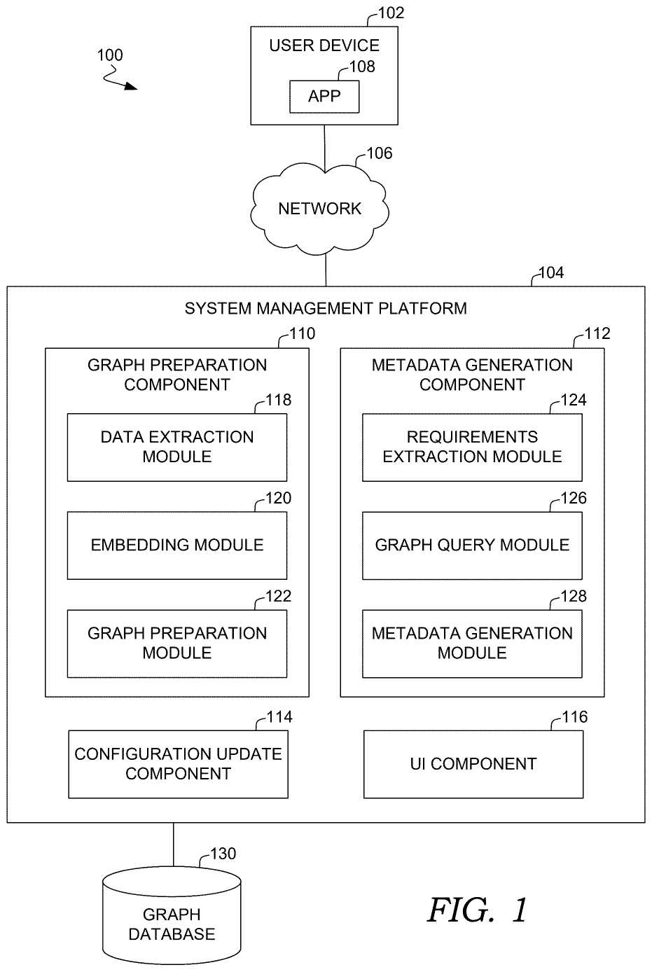

With reference now to the drawings, FIG. 1 is a block diagram illustrating an exemplary system 100 for employing metadata generation and analysis to facilitate configuration management of interdependent software components in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

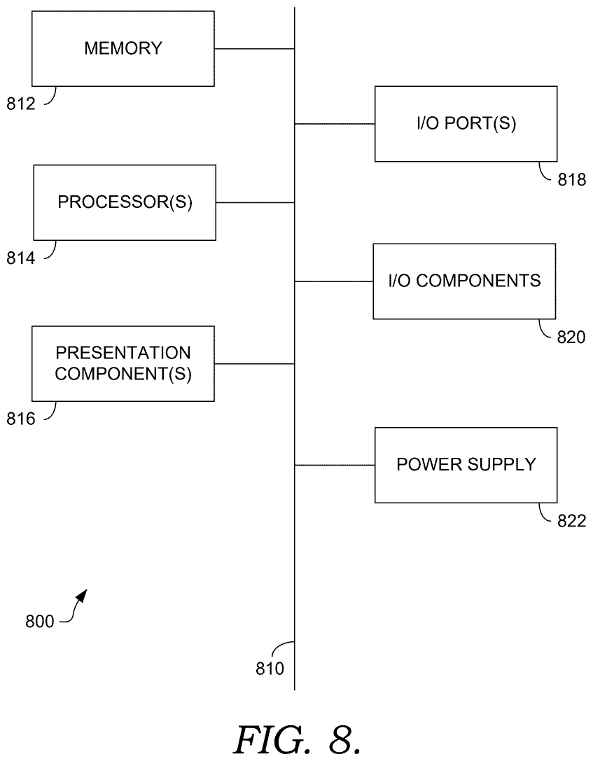

The system 100 is an example of a suitable architecture for implementing certain aspects of the present disclosure. Among other components not shown, the system 100 includes a user device 102 and a system management platform 104. Each of the user device 102 and the system management platform 104 shown in FIG. 1 can comprise one or more computer devices, such as the computing device 800 of FIG. 8, discussed below. As shown in FIG. 1, the user device 102 and the system management platform 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the system management platform 104 could be provided by multiple server devices collectively providing the functionality of the system management platform 104 as described herein. Additionally, other components not shown may also be included within the network environment.

The user device 102 can be a client device on the client-side of the system 100, while the system management platform 104 can be on the server-side of the system 100. The system management platform 104 can comprise server-side software designed to work in conjunction with client-side software on the user device 102 so as to implement any combination of the features and functionalities discussed in the present disclosure. For instance, the user device 102 can include an application 108 for interacting with the system management platform 104. The application 108 can be, for instance, a web browser or a dedicated application for providing functions, such as those described herein. This division of the system 100 is provided to illustrate one example of a suitable environment, and there is no requirement for each implementation that any combination of the user device 102 and the system management platform 104 remain as separate entities. While the system 100 illustrates a configuration in a networked environment with a separate user device and system management platform, it should be understood that other configurations can be employed in which aspects of the various components are combined. For instance, in some aspects, aspects of the system management platform 104 can be implemented in part or in whole by the user device 102.

The user device 102 can comprise any type of computing device capable of use by a user. For example, in one aspect, the user device 102 may be the type of computing device 800 described in relation to FIG. 8 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a worksta-tion, or any combination of these delineated devices, or any other suitable device. A user can be associated with the user device 102 and can interact with the system management platform 104 via the user device 102.

The system management platform 104 generally facilitates management of interdependent software components within a system. In accordance with aspects of the technology described herein, the system management platform 104 generates a knowledge graph regarding the system and employs the knowledge graph to coordinate configuration updates to software components of the system in response to system updates. As shown in FIG. 1, the system management platform 104 includes a graph preparation component 110, a metadata generation component 112, a configuration update component 114, and a user interface component 116. The components/modules of the system management platform 104 may be in addition to other components/modules that provide further additional functions beyond the features described herein. The system management platform 104 can be implemented using one or more server devices, one or more platforms with corresponding application programming interfaces, cloud infrastructure, and the like. While the system management platform 104 is shown separate from the user device 102 in the configuration of FIG. 1, it should be understood that in other configurations, some or all of the functions of the system management platform 104 can be provided on the user device 102. Additionally, in some configurations, one or more of the components/modules of the system management platform 104 shown in FIG. 1 can be provided by the user device 102 and/or another location not shown in FIG. 1. The components/modules can be provided by a single entity or multiple entities.

In some aspects, the functions performed by components/modules of the system management platform 104 are associated with one or more applications, services, or routines. In particular, such applications, services, or routines may operate on one or more user devices, servers, may be distributed across one or more user devices and servers, or be implemented in the cloud. Moreover, in some aspects, these components/modules of the system management platform 104 may be distributed across a network, including one or more servers and client devices, in the cloud, and/or may reside on a user device. Moreover, these components/modules, functions performed by these components/modules, or services carried out by these components/modules can be implemented at appropriate abstraction layer(s) such as the operating system layer, application layer, hardware layer, etc., of the computing system(s). Alternatively, or in addition, the functionality of these components/modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components/modules shown in example system 100, it is contemplated that in some aspects, functionality of these components/modules can be shared or distributed.

The graph preparation component 110 of the system management platform 104 generates a knowledge graph from system configuration information for a system with multiple interdependent software components. As used herein, system configuration information refers to information regarding details and settings that define the setup and operation of software components of a system. Examples of sources of such information include product requirements documents (PRDs), functional specifications documents (FSDs), business requirements documents (BRDs), technical specifications, and design specifications, to name a few.

The graph preparation component 110 transforms the system configuration information, which can include unstructured and structured data, into a structured knowledge graph that can be utilized for various purposes, including dependency analysis and intelligent recommendations for managing the software components of the system. In some aspects, the graph preparation component 110 can continue to build and/or update the knowledge graph over time as software components are added, removed, and/or modified. As described in further detail below, the graph preparation component 110 can leverage advanced AI and language understanding techniques to ensure the accuracy and comprehensiveness of the generated knowledge graph.

As shown in FIG. 1, the graph preparation component 110 includes a data extraction module 118, an embedding module 120, and a graph preparation module 122. The data extraction module 118 extracts data from system configuration information for generating the knowledge graph. This can include parsing the system configuration information to identify key entities, software components, and relationships among the entities and software components. The data extraction module 118 also identifies attributes of the entities and the software components. The attributes of the entities and the software components can include information, such as unique identifiers, descriptions, and other general attributes. The attributes of software components can also include configuration metadata. Configuration metadata for a software component refers to data regarding settings and parameters that influence how the software component operates within the system. The configuration metadata can be modified to alter the behavior of the software component without changing the software code itself, allowing for increased flexibility and customization.

The data extraction module 118 employs a language model to extract relevant data from system configuration information for generating the knowledge graph. In some aspects, the input to the language model can be the raw system configuration information. In other aspects, the system configuration information can be pre-processed before input to the language model. For instance, the data extraction module 118 can employ a splitter to generate snippets from the system configuration information, and the language model processes the snippets to extract relevant data. The language model analyzes the text to identify entities, software components, relationships among these entities and software components, and attributes of entities and software components, including configuration metadata for the software components. The data extraction module 118 ensures that the extracted information is precise and relevant, providing a foundation for the subsequent steps in the graph preparation process.

The embedding module 120 generates embeddings for the configuration metadata extracted for each software component by the data extraction module 118. The embedding module 120 can leverage a pre-trained embedding model to create metadata embeddings (e.g., vector representations) of the configuration metadata for the software components. The metadata embeddings capture the semantic meaning of the configuration metadata, allowing for more accurate and relevant searches within the knowledge graph. In some aspects, the metadata embeddings are used to generate a vector index that facilitates the efficient identification of relevant software components and associated entities from the knowledge graph when performing system updates.

The graph preparation module 122 uses the extracted data and metadata embeddings to prepare the knowledge graph, which is stored in a graph database 130. The graph preparation module 122 organizes the extracted information into a structured graph that can be used for various purposes, including dependency analysis and intelligent recommendations. The nodes in the graph represent entities and software components, each with associated attributes (including configuration metadata for the software components), while the edges represent the relationships among these entities and software components. The graph preparation module 122 ensures that the graph is comprehensive and accurate, capturing the relevant entities, software components, relationships, attributes, and configuration metadata. The metadata embeddings can be stored with each software component node, enhancing the knowledge graph's utility for various applications.

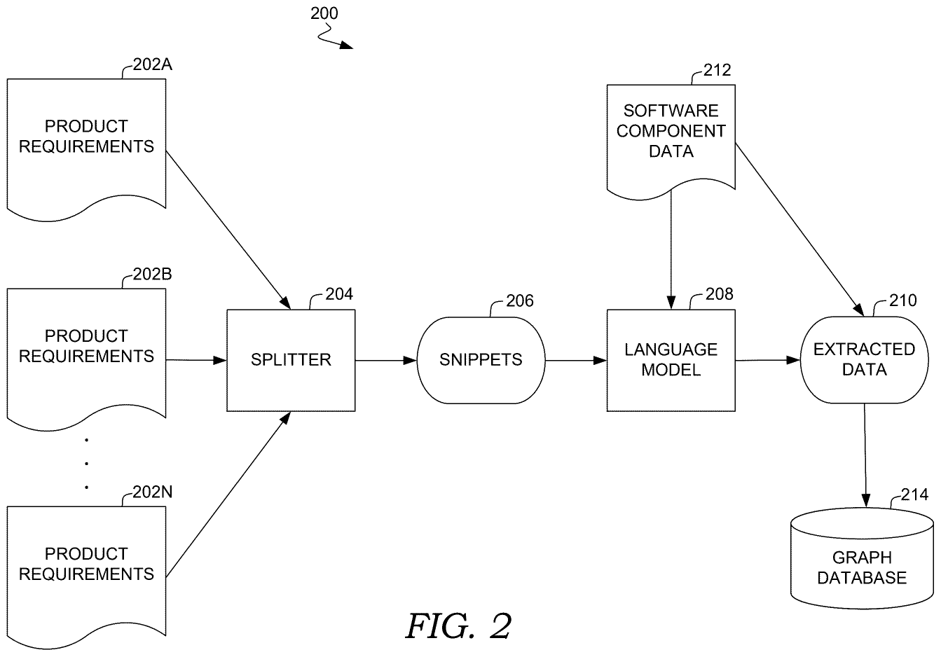

FIG. 2 provides a block diagram showing operations 200 that can be performed by the graph preparation component 110 of FIG. 1 to prepare a knowledge graph. As shown in FIG. 2, system configuration information is accessed, which in this example includes product requirement documents 202A-202N. A splitter 204 parses the text from the product requirements documents 202A-202N in order to break down the documents into smaller, more manageable snippets 206. Any size snippet can be employed within the scope of this technology. In some aspects, the splitter 204 uses algorithms to identify natural breaks in the text, such as sentences, paragraphs, or sections, ensuring that each snippet is coherent and maintains contextual meaning. In other configurations, the splitter 204 can generate equal length snippets and/or can have token overlaps or no overlaps across the snippets.

The snippets 206 are processed by a language model 208 to extract relevant data, including key entities, software components, and relationships among them. The extracted data can also include attributes of the entities and software components, such as unique identifiers, descriptions, and configuration metadata. In some configurations, software component data 212 regarding the software components can be provided in addition to the product requirements documents 202A-202N. In some configurations, the software component data 212 is also processed by the language model 208 to extract relevant data; while in other configurations, the software component data 212 can be structured data added to the knowledge graph without processing by a language model.

The extracted data 210 is used to generate a knowledge graph, which is stored in a graph database 214. This can involve organizing the extracted data into a structured graph that represents entities and software components as nodes, with edges denoting the relationships among entities and software components. Attributes of each node and each edge are also stored as part of the knowledge graph. In some aspects, this can include generating metadata embeddings of configuration metadata for the software components and storing the metadata embedding with the node for the corresponding software component in order to facilitate accurate and efficient searches for relevant graph data within the knowledge graph.

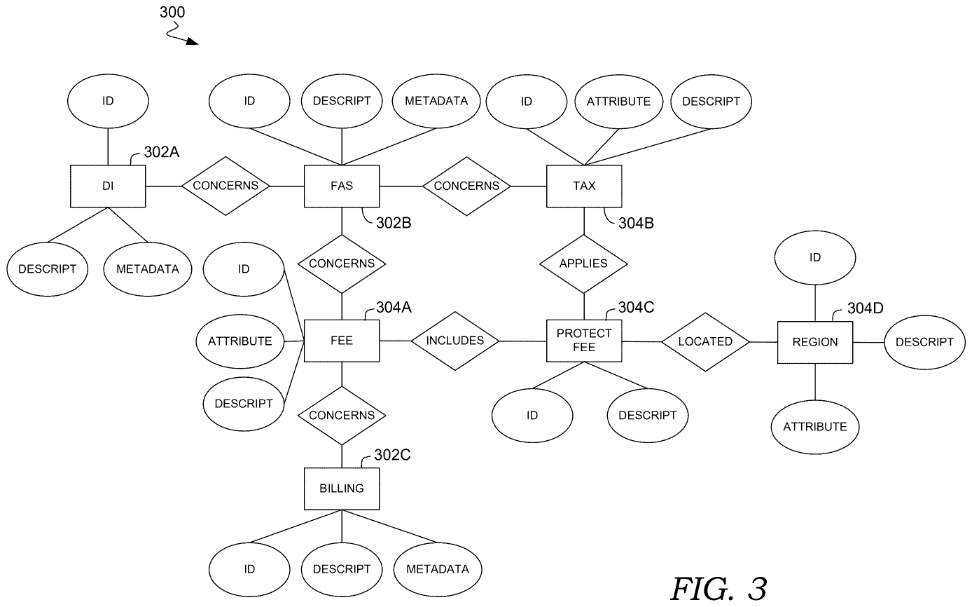

By way of illustration, FIG. 3 provides a block diagram showing an example of a knowledge graph 300 for a system of interdependent software components. It should be noted that the knowledge graph 300 is a simplified graph and that, in practice, a knowledge graph can include a much larger number of nodes and edges. In the knowledge graph 300, each node is shown as a block and each edge is shown as a line connecting blocks. In this example, the knowledge graph 300 includes three nodes 302A, 302B, and 302C for software components in the computer system, as well as four nodes 304A, 304B, 304C, and 304D for entities associated with the software components. Each node includes any number of attributes (e.g., ID, description, and other attributes), which are shown as ovals connected to each node in FIG. 3. The nodes 302A, 302B, and 302C for the software components also have associated configuration metadata. The edges between the nodes also have attributes, which are shown as triangles in FIG. 3. An edge attribute can define a type of relationship between two entities.

With reference again to FIG. 1, the knowledge graph provided by the graph preparation component 110 is used by the metadata generation component 112 when processing system updates. The system updates can be provided, for instance, by new system configuration information via documentation, such as updated or new PRDs, FSDs, BRDs, technical specifications, or design specifications. As shown in FIG. 1, the metadata generation component 112 includes a requirements extraction module 124, a graph query module 126, and a metadata generation module 128. As described in further detail below, these modules of the metadata generation component 112 extract relevant data from information regarding a system update and perform an impact assessment for the system update to retrieve relevant graph data from the knowledge graph for impacted entities and software components. The extracted data and retrieved graph data are then used to generate generic update metadata providing information for updating each of the impacted software components. This ensures that the generic update metadata accurately reflects the new product requirements for the system update and the associated impacts on various entities and software components within the system.

When new system configuration information is received for a system update, the requirements extraction module 124 employs a language model to extract requirements metadata. The requirements metadata provides information regarding the system update, including entities and/or software components included in the new system configuration information. For instance, the language model can be trained to understand the context and nuances of system configuration information, enabling it to accurately extract relevant data for the system update.

The graph query module 126 uses the requirements metadata extracted by the requirements extraction module 124 to query the graph database 130. By querying the graph database 130, the graph query module 126 retrieves relevant graph data, which can include an identification of entities and software components that are impacted by the system update and associated information (e.g., relationships and attributes). In some cases, the graph data is a subgraph from the knowledge graph relevant to the requirements metadata, including entity and software component nodes with their attributes and configuration metadata, as well as the edges between these nodes.

The graph query module 126 can use different querying techniques to navigate the knowledge graph in the graph database 130 and identify the relevant graph data. For instance, the graph query module 126 can use graph traversal algorithms and other methods to ensure that all relevant entities and software components are identified and retrieved based on the requirements metadata. The graph query module 126 can handle complex queries and is designed to work efficiently with large and intricate knowledge graphs. In some aspects, the knowledge graph comprises a vector index with metadata embeddings for configuration metadata of software components in the system. The graph query module 126 can generate one or more requirements embeddings from the requirements metadata, and identify relevant software components based on similarity of their metadata embeddings to the requirements embeddings. The similarity can be, for instance, based on distance in an embedding space (e.g., cosine similarity). In some instance, a similarity threshold can be employed to identify impacted software components. In particular, software components with metadata embeddings that have a similarity satisfying the similarity threshold can be identified as impacted software components.

Based on the identification of entities and software components from querying the graph database 130 using the requirements metadata, the attributes and configuration metadata of each relevant node is accessed, as well each node's relationships to other nodes. This retrieved graph data can be assembled into a context for subsequent processing by the metadata generation module 128.

The metadata generation module 128 takes the requirements metadata and the relevant graph data and generates generic update metadata for the system update. In some aspects, the metadata generation module 128 employs a language model that analyzes the requirements metadata and the retrieved graph data to generate the generic update metadata. The retrieved graph data can include attributes for each entity and each software component in the retrieved graph data. These attributes can be used by the metadata generation module 128 when generating the generic update metadata by identifying attributes that are impacted by the system update.

The generic update metadata can comprise text (e.g., natural language text) that describes the updates without being precisely structured for updating the configurations for each software component. The generic update metadata can identify the entities and software components impacted by the system update, as well as details regarding how each entity and software component is impacted. The generic update metadata provides sufficient information that can be used by the configuration update component 114 to update configurations of the impacted software components, as will be described in further detail below.

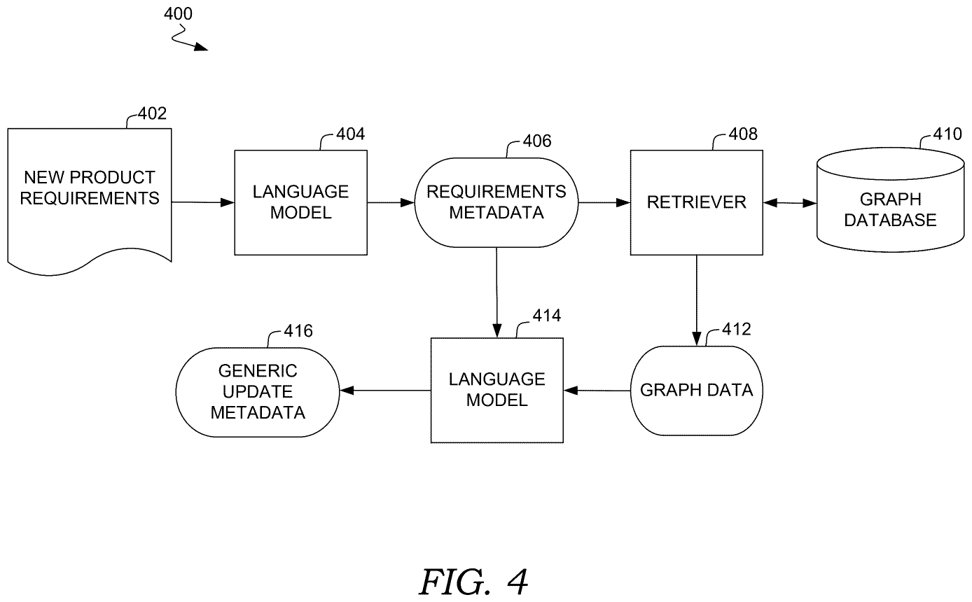

FIG. 4 provides a block diagram showing operations 400 that can be performed by the metadata generation component 112 of FIG. 1 to generate generic update metadata for a system update. As shown in FIG. 4, new system configuration information for a system update is accessed, which in this example includes product requirements document 402. The product requirements document is processed by a language model 404, which extracts requirements metadata 406 regarding the system update. The requirements metadata 406 is then utilized by a retriever 408 to query a graph database 410, which stores a knowledge graph for the system. The retriever 408 retrieves graph data 412 from the graph database 410 that is relevant to the requirements metadata 406. The graph data 412 can be, for instance, a subgraph of the knowledge graph capturing nodes of impacted entities and software components, as well as their relationships and associated attributes and configuration metadata. In some aspects, this can include generating embeddings from the requirements metadata 406 and using the embeddings to search a vector index with metadata embeddings to identify relevant software components and associated entities.

The requirements metadata 406 and the graph data 412 are processed by a language model 414 to generate generic update metadata 416. This generic update metadata 416 can provide information for updating configurations for each of the impacted software components, ensuring that the updates accurately reflect the new product requirements and their associated impacts on various entities and software components within the system.

With reference again to FIG. 1, the configuration update component 114 converts generic update metadata for a system update provided by the metadata generation component 112 into component-specific metadata that is used to update the configurations of impacted software components. The configuration update component 114 ensures that the generic update metadata is accurately translated to update the configuration of each impacted software component.

The generic update metadata can provide details of the changes for each impacted software component and other relevant contextual information. The configuration update component 114 analyzes this generic update metadata to identify the specific requirements and configurations needed for each impacted software component. In some aspects, the configuration update component 114 can employ a language model to intelligently interpret the generic update metadata, assess the impact on each software component, and generate precise, component-specific metadata. This can involve translating the generic update metadata into component-specific for-mats and structures.

Once the component-specific metadata is generated, the configuration update component 114 proceeds to update the configurations of the impacted software components using the component-specific metadata. This ensures that each impacted software component has the precise metadata in its configuration needed to implement the system update.

The language models used by the system management platform 104 can include a set of statistical or probabilistic functions to perform natural language processing (NLP) in order to understand, learn, and/or generate human natural language text and code. For example, a language model can be a tool that determines the probability of a given sequence of words occurring in a sentence, natural language sequence, and/or code. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes all with limited to no supervision. Accordingly, an LLM can comprise a deep neural network that is very large (e.g., billions to hundreds of billions of parameters) and understands, processes, and produces human natural language and code by being trained on massive amounts of text. These models can predict future words in a sequence letting them, for instance, generate sentences similar to how humans talk and write or otherwise in a form dictated, for instance, by a prompt.

The system management platform 104 can use any number of language models to perform the tasks described herein. For instance, in some cases, a pre-trained language model can be used to perform each task. In other cases, different language models can be used for different tasks. In accordance with some aspects, each language model used by the system management platform 104 comprises a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some aspects, language models used by the system management platform 104 can be pre-trained models without any fine-tuning. In other aspects, language models used by the system management platform 104 can be models trained from scratch or pre-trained models that have been fine-tuned for the tasks described herein. During training/fine-tuning, parameters (e.g., weights) associated with each neuron can be updated. Originally, a language model can comprise random weight values or pre-trained weight values that are adjusted during training. In one aspect, the generative model is trained using backpropagation. The backpropagation process comprises a forward pass, a loss function, a backward pass, and a weight update. For instance, a forward pass could comprise providing a sample input from a training sample to the language model, which generates an output. A loss could then be determined based on a comparison of the output and ground truth data from the training sample, and weights of the generative model are updated based on the loss. This process is repeated using the training data. The goal is to update the weights of each neuron (or other model component) to cause the generative model to produce useful output when given prompts. Once trained, the weight associated with a given neuron can remain fixed. The other data passing between neurons can change in response to a given input. Retraining the network with additional training data can update one or more weights in one or more neurons.

The system management platform 104 further includes a user interface component 116 that provides one or more user interfaces for users to interact with the system management platform 104. For instance, the user interface component 116 provides one or more user interfaces to user devices, such as the user device 102. In some instances, the user interfaces can be presented on the user device 102 via the application 108, which can be a web browser or a dedicated application for interacting with the system management platform 104. Among other things, the user interface component 116 can provide user interfaces for interacting with the system management platform 104 to facilitate system updates impacting interdependent software components. For instance, the user interface component 116 can provide user interfaces enabling users to submit new system configuration information for a system update and view information generated by the system management platform 104 during the update process. In some aspects, the system management platform 104 facilitates an interactive update process in which a user can provides inputs during various stages in the process. For instance, the system management platform 104 could provide the generic update metadata for the user to view and potentially edit before the generic update metadata is translated to component-specific metadata that is used to update component configurations.

The following provides a discussion of an example operation of performing a system update with reference to the knowledge graph 300 of FIG. 3. Suppose that a product manager uploads a PRD explaining that a new protection fee must be collected for any buyer whose shipping address is in the United States, specifically for California shipments. The PRD also stipulates a 5% surcharge and corresponding changes to sales tax liability accounts. The platform splits the PRD into smaller text snippets and runs them through a language model to extract requirements metadata, including relevant keywords and phrases, such as, for instance: “Fee,” “Tax,” “Region: US/CA,” “5%,” “Sales Tax Liability (1003).”

Based on the extracted requirements metadata, the platform retrieves relevant graph data. The requirements data and graph data are processed by a language model to generate generic update metadata. For instance, based on the example PRD, the following generic update metadata could be generated for various entities and software components: (1) Fee: Protection Fee (5%); (2) Tax: Applies to US, CA; (3) FAS: Must include a new ledger code referencing “Sales Tax Liability (1003).” and (4) Billing: Must reflect the new “fee_config” for 5%. In this example, “Fee” corresponds to an entity referenced as node 304A in FIG. 3; “Tax” corresponds to an entity referenced as node 304B in FIG. 3; “FAS” corresponds to a software component referenced as node 302B in FIG. 3; and “Billing” corresponds to a software component referenced as node 302C in FIG. 3.

This generic update metadata is translated into component-specific metadata, which is used to update the configurations of the “FAS” software component and the “Billing” software component. In particular, the “FAS” software component receives updated “master_data” entries denoting the new region code (CA), the finance book account for “Sales Tax Liability (1003),” and journaling instructions. The “Billing” software component is updated with a “fee_config” attribute so that any invoice calculation for a buyer shipping to California includes the additional 5% fee. At deployment time, no further manual coding is required in each component's configuration files or database entries; and the system ensures that these changes are propagated seamlessly downstream.

In addition to its above-discussed functions, the system management platform 104 also incorporates various alternatives and enhancements to improve its efficiency and effective-ness. For instance, it can utilize intelligent recommendations to provide context-aware suggestions for configuration changes and decisions, reducing errors and avoiding redundant discussions. Automated alignment and management tools ensure consistency and alignment across teams and components, minimizing delays caused by miscommunication or lack of transparency. The system management platform 104 also supports continuous validation tests and robust database management to maintain data integrity and ensure consistency across software components. By automating the creation of configurations and minimizing manual interventions, the system management platform 104 streamlines the end-to-end delivery process, enabling faster and more reliable program launches.

### Example Methods for Configuration Management of Interdependent Software Components

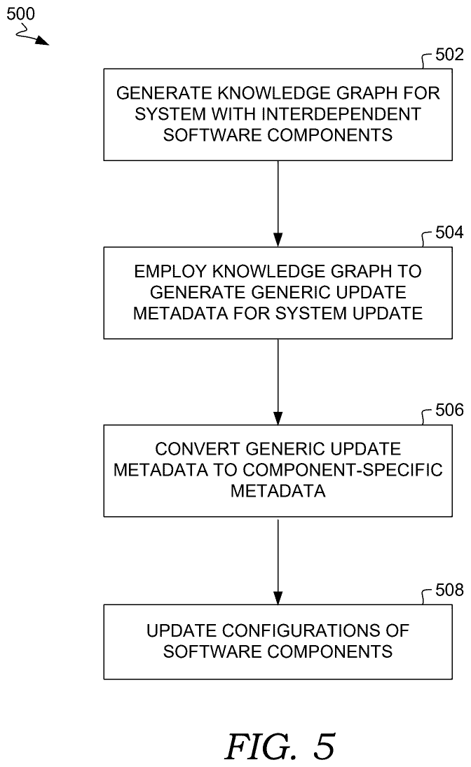

With reference now to FIG. 5, a flow diagram is provided that illustrates an overall method 500 for configuration management of interdependent software components. The method 500 can be performed, for instance, at least in part by the system management platform 104 in FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, a knowledge graph is generated for a system with interdependent software components. This can involve extracting data from system configuration information using a language model. The extracted data includes entities, software components, and their relationships, which are then structured into a knowledge graph. This knowledge graph serves as a comprehensive representation of the system, capturing the dependencies and interactions among various software components and associated entities. The knowledge graph is stored in a graph database, allowing for efficient querying and updates.

The knowledge graph is employed to generate generic update metadata for a system update, as shown at block 504. For instance, when new system configuration information is received for the system update, a language model can process this information to extract requirements metadata. This requirements metadata can be used to query the knowledge graph, retrieving relevant graph data about the impacted entities and software components. The retrieved graph data, along with the requirements metadata, can be used to generate the generic update metadata. This generic update metadata provides a high-level description of the changes needed for the system update, ensuring that all impacted software components are identified and addressed.

As shown at block 506, the generic update metadata is converted into component-specific metadata. This can involve analyzing the generic update metadata to determine the specific configuration changes required for each impacted software component. A language model may be used to interpret the generic update metadata and generate precise, component-specific metadata. The component-specific metadata details the exact changes needed for each software component, ensuring that the system update is implemented accurately and efficiently.

The component-specific metadata is used to update the configurations of the impacted software components, as shown at block 508. This can include, for instance, applying the component-specific metadata to configurations of respective software components. The configurations are updated to reflect the new system requirements, ensuring that all software components are aligned and functioning correctly. This process may include modifying configuration files, updating database entries, and performing validation tests to ensure the changes are correctly implemented.

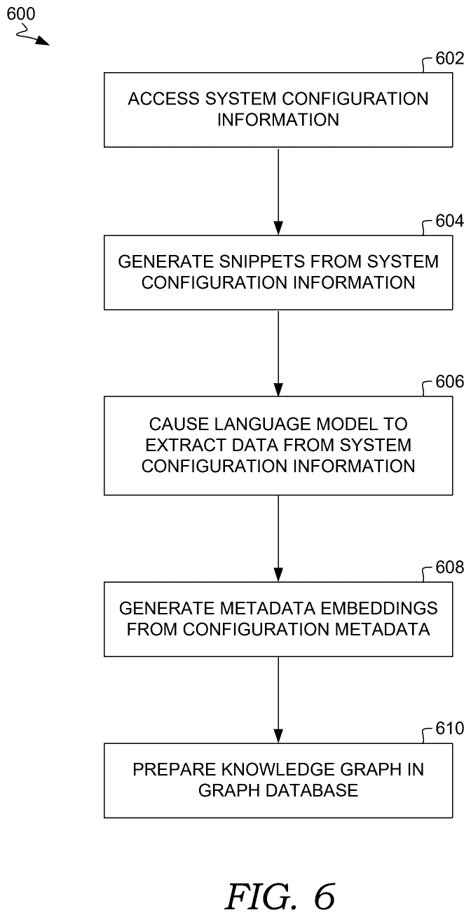

FIG. 6 provides a flow diagram showing a method 600 for preparing a knowledge graph for a system to facilitate component management for system updates. The method 600 can be performed, for instance, at least in part by the system management platform 104 in FIG. 1. As shown at block 602, system configuration information for a system is accessed. This can include retrieving detailed information about the system's setup and operation, including data on various software components and their interactions. For instance, the system configuration information can be sourced from documents such as product requirements, functional specifications, and technical design documents. This information forms the foundation for subsequent steps in the process, ensuring that all relevant details are considered.

Snippets are generated from the system configuration information, as shown at block 604. This can involve breaking down the comprehensive system configuration information into smaller, manageable pieces or snippets. These snippets are created to facilitate easier processing and analysis. The snippets can be generated based on natural breaks in the text, such as sentences or paragraphs, or by using predefined lengths.

As shown at block 606, a language model extracts data from the system configuration information for preparing a knowledge graph. The language model processes the generated snippets to identify key entities, software components, and their relationships. The language model leverages natural language processing techniques to accurately extract relevant data, ensuring that the extracted information is precise and comprehensive. This extracted data also includes attributes and configuration metadata for each software component.

Metadata embeddings are generated from the configuration metadata for the software components, as shown at block 608. This can involve creating vector representations, or embeddings, of the configuration metadata for each software component. These metadata embeddings capture the semantic meaning of the configuration metadata, enabling more accurate and efficient searches within the knowledge graph. The metadata embeddings can be generated using a pre-trained embedding model, which ensures that the vector representations are meaningful and relevant.

As shown at block 610, the extracted data is used to prepare the knowledge graph, which is stored in a graph database. This can include organizing the extracted data and metadata embeddings into a structured knowledge graph. The knowledge graph includes nodes representing the software components and entities, with edges denoting their relationships. The graph is stored in a graph database, which allows for efficient querying and updates. This structured representation of the system configuration information facilitates dependency analysis and intelligent recommendations for managing software components.

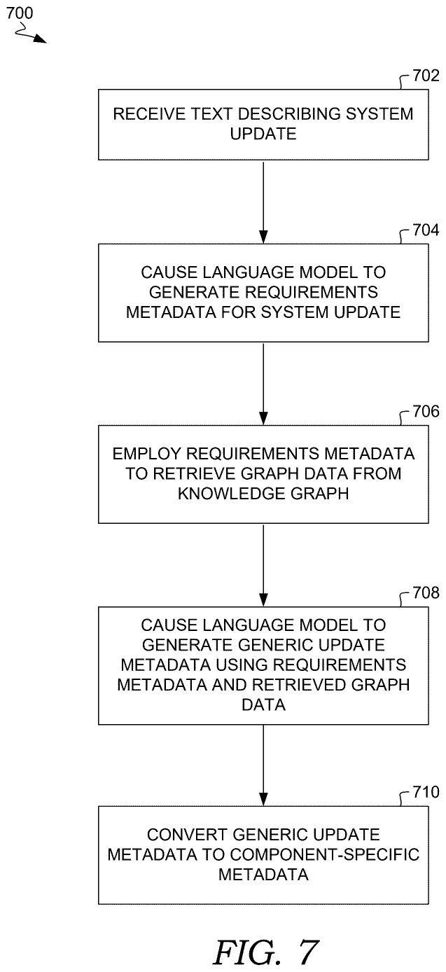

FIG. 7 provides a flow diagram showing a method 700 for employing a knowledge graph for a system to update configurations of software components based on a system update. The method 700 can be performed, for instance, at least in part by the system management platform 104 in FIG. 1. As shown at block 702, text describing a system update is received. This step involves obtaining detailed information about the proposed changes to the system, which involve modifications to existing software components. The text can be sourced from various documents, such as product requirements, technical specifications, or business requirements. This ensures that all relevant details about the system update are captured for further processing.

As shown at block 704, a language model generates requirements metadata for the system update. A language model processes the received text to extract key information. The requirements metadata provides a structured representation of the system update, highlighting the specific changes needed. This metadata is used for accurately assessing the scope of the update and identifying impacted parts of the system.

The requirements metadata are to retrieve graph data from the knowledge graph, as shown at block 706. This involves, for instance, querying the knowledge graph, which contains a comprehensive representation of the system, including entities, software components, and their relationships. The query retrieves relevant graph data about the impacted software components and their dependencies, ensuring that the system update is implemented correctly. The retrieved graph data provides context and detailed information about the impacted parts of the system, facilitating accurate and efficient updates.

As shown at block 708, a language model generates generic update metadata using the requirements metadata and the retrieved graph data. The language model synthesizes the information from the requirements metadata and graph data to create generic update metadata. This generic update metadata provides a high-level description of the changes needed for the system update, ensuring that all impacted software components are identified and addressed. The generic update metadata serves as a blueprint for updating configurations of impacted parts of the system, guiding the detailed implementation of the system update.

The generic update metadata is transformed to component-specific metadata at block 710. This can involve analyzing the generic update metadata to determine the specific configuration changes required for each impacted software component. A language model may be used to interpret the generic update metadata and generate precise, component-specific metadata. The component-specific metadata details the exact changes needed for each component, ensuring that the system update is implemented accurately and efficiently. The component-specific metadata is used to update the configurations of the impacted software components, ensuring that the system operates smoothly with the new changes in place.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or ma-chine-useable instructions, including computer-executable instructions such as program modules, being executed by a computer or other machine, such as a personal data assistant or other hand-held device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may con-sider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other op-tical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or non-volatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
generating a knowledge graph using a first language model to extract data from system configuration information for a plurality of interdependent software components, the knowledge graph comprising nodes representing the plurality of interdependent software components and a plurality of entities identified from the system configuration information, the knowledge graph also comprising edges representing relationships among the plurality of interdependent software components and the plurality of entities;
receiving new system configuration information for a system update impacting the plurality of interdependent software components;
generating generic update metadata for the system update using a second language model to process data based on requirements metadata from the new system configuration information and graph data retrieved from the knowledge graph;
transforming the generic update metadata into component-specific metadata for each of the plurality of interdependent software components; and
updating a configuration for each of the plurality of interdependent software components using the component-specific metadata.

2. The one or more computer storage media of claim 1, wherein generating the knowledge graph comprises:
generating snippets from the system configuration information; and
causing the first language model to identify the plurality of entities and relationships among the plurality of entities from the snippets.

3. The one or more computer storage media of claim 2, wherein the first language model also identifies the plurality of interdependent software components and relationships among the plurality of interdependent software components from the snippets.

4. The one or more computer storage media of claim 1, wherein generating the knowledge graph comprises:
identifying configuration metadata for each of the plurality of interdependent software components;
generating a metadata embedding from the configuration metadata for each of the plurality of interdependent software components; and
providing a vector index using the metadata embedding.

5. The one or more computer storage media of claim 1, wherein generating the generic update metadata for the system update comprises:
performing an impact assessment for the system update to retrieve the graph data from the knowledge graph; and
causing the second language model to synthesize the generic update metadata using the requirements metadata from the new system configuration information and the graph data.

6. The one or more computer storage media of claim 5, wherein performing the impact assessment for the system update comprises:
generating the requirements metadata for the system update using a third language model to process text from the new system configuration information; and
retrieving the graph data from the knowledge graph using the requirements metadata.

7. The one or more computer storage media of claim 6, wherein retrieving the graph data from the knowledge graph using the requirements metadata comprises:
generating an embedding for the requirements metadata; and
using the embedding for the requirements metadata to perform a similarity search on a vector index storing metadata embeddings for the plurality of interdependent software components.

8. The one or more computer storage media of claim 6, wherein each node in the graph data retrieved from the knowledge graph has one or more attributes, and wherein the second language model synthesizes the generic update metadata using at least a portion of the one or more attributes.

9. A computer-implemented method comprising:
causing a first language model to extract a plurality of entities and relationships among the plurality of entities from system configuration information associated with a plurality of interdependent software components;
storing, in a knowledge graph, representations of the plurality of entities and the plurality of interdependent software components as nodes with edges representing relationships among the plurality of interdependent software components and the plurality of entities;
receiving system update information for a system update impacting the plurality of interdependent software components;
causing a second language model to generate generic update metadata for the system update using the knowledge graph and the system update information; and
transforming the generic update metadata into component-specific metadata for each of the plurality of interdependent software components.

10. The computer-implemented method of claim 9, further comprising:
updating a configuration for each of the plurality of interdependent software components using the component-specific metadata.

11. The computer-implemented method of claim 9, wherein causing the first language model to extract the plurality of entities and relationships among the plurality of entities from the system configuration information comprises:
splitting the system configuration information into a plurality of snippets; and
providing the plurality of snippets to the first language model.

12. The computer-implemented method of claim 9, wherein causing the second language model to generate the generic update metadata for the system update using the knowledge graph comprises:
performing an impact assessment for the system update to retrieve one or more relevant subgraphs from the knowledge graph; and
causing the second language model to synthesize the generic update metadata using the system update information and the one or more relevant subgraphs.

13. The computer-implemented method of claim 12, wherein each of one or more graph nodes in the knowledge graph has a metadata embedding providing a plurality of metadata embeddings for the knowledge graph, and the one or more relevant subgraphs are retrieved based on at least one of the plurality of metadata embeddings.

14. The computer-implemented method of claim 13, wherein performing the impact assessment for the system update comprises:
causing a third language model to provide requirements metadata for the system update based on the system update information;
generating an embedding for the requirements metadata; and
using the embedding for the requirements metadata to perform a similarity search on a vector index storing the plurality of metadata embeddings for the knowledge graph.

15. The computer-implemented method of claim 12, wherein each graph node in the knowledge graph has one or more attributes, and wherein the second language model synthesizes the generic update metadata using at least one attribute for at least one graph node in the one or more relevant subgraphs.

16. A computer system comprising:
one or more processors; and
one or more computer storage media storing computer-useable instructions that, when used by the one or more processors, cause the one or more processors to perform operations, the operations comprising:
receiving system configuration information for a system update to a system comprising a plurality of interdependent software components;
generating requirements metadata regarding the system update using a first language model to process the system configuration information;
retrieving, from a knowledge graph for the system, graph data relevant to the requirements metadata;
generating generic update metadata for the system update using a second language model to process the requirements metadata and the graph data;
transforming the generic update metadata to component-specific metadata; and
updating a configuration of at least one of the plurality of interdependent software components using at least a portion of the component-specific metadata.

17. The computer system of claim 16, wherein the knowledge graph comprises a plurality of nodes representing a plurality of entities and the plurality of interdependent software components, and wherein the knowledge graph also comprises a plurality of edges between nodes in the plurality of nodes representing relationships among the plurality of interdependent software components and the plurality of entities.

18. The computer system of claim 16, wherein each interdependent software component comprises configuration metadata, and the knowledge graph includes a vector index storing metadata embeddings for the configuration metadata.

19. The computer system of claim 18, wherein retrieving the graph data relevant to the requirements metadata comprises:
generating at least one requirements embedding using the requirements metadata;
querying the vector index using the at least one requirements embedding to identify one or more metadata embeddings having a similarity to the at least one requirements embedding that satisfies a similarity threshold; and
retrieving data from the knowledge graph for one or more interdependent software component corresponding to the one or more metadata embeddings.

20. The computer system of claim 16, wherein each graph node in the knowledge graph has one or more attributes, and wherein the second language model synthesizes the generic update metadata using at least one attribute for at least one graph node in the graph data.
